(19) United States
(12) Patent Application Publication
(10) Pub. No.: US 2026/0342682 A1
(43) Pub. Date: Oct. 29, 2026

(54) COMMUNICATION CONTROL METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/715,418

(22) Filed: Jun. 22, 2026

Related U.S. Application Data
(63) Continuation of application No. PCT/JP2024/045037, filed on Dec. 19, 2024.

(30) Foreign Application Priority Data
Dec. 22, 2023 (JP) 2023-217328

(51) Int. Cl. H04L 41/16; H04L 43/0817

(52) U.S. Cl. CPC H04L 41/16; H04L 43/0817

(57) ABSTRACT

A communication control method according to an aspect is a communication control method in a mobile communication system. The communication control method includes acquiring, by a user equipment, model identification information for identifying an AI/ML model and additional information of the AI/ML model. The communication control method includes transmitting, by the user equipment, the model identification information to a network apparatus. Here, the transmitting includes transmitting, by the user equipment, the model identification information to the network apparatus when determining that inference for the AI/ML model is possible based on the additional information.

### RELATED APPLICATIONS

The present application is a continuation based on PCT Application No. PCT/JP 2024/045037, filed on Dec. 19, 2024, which claims the benefit of Japanese Patent Application No. 2023-217328 filed on Dec. 22, 2023. The content of which is incorporated by reference herein in their entirety.

### TECHNICAL FIELD

The present disclosure relates to a communication control method and a user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-patent Document 1:3gpp Tr 38.843 V 2.0.0 (2023-12)

### SUMMARY

A communication control method according to a first aspect is a communication control method in a mobile communication system. The communication control method includes acquiring, by a user equipment, model identification information for identifying an AI/ML model and additional information of the AI/ML model. The communication control method includes transmitting, by the user equipment, the model identification information to a network apparatus. Here, the transmitting includes transmitting, by the user equipment, the model identification information to the network apparatus when determining that inference for the AI/ML model is possible based on the additional information.

A communication control method according to a second aspect is a communication control method in a mobile communication system. The communication control method includes causing, by a user equipment, an AI/ML model to perform training. The communication control method includes transmitting, by the user equipment, a parameter used for training and additional information of the AI/ML model to a network apparatus. Here, in the network apparatus, training of the AI/ML model is performed by using the parameter.

A communication control method according to a third aspect is a communication control method in a mobile communication system. The communication control method includes causing, by a network apparatus, an AI/ML model to perform training. The communication control method includes transmitting, by a network apparatus, identification information of an AI/ML model and additional information of the AI/ML model to a user equipment. Here, the additional information is used, by a user equipment, for one of determining whether to perform inference of the AI/ML model or determining whether to transmit a parameter used for inference to a network apparatus.

### BRIEF DESCRIPTION OF THE DRAWINGS

FIG. 1 is a diagram illustrating a configuration example of a mobile communication system according to a first embodiment.

FIG. 2 is a diagram illustrating a configuration example of user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an operation example according to the first embodiment.

FIG. 11 is a diagram illustrating an example of a configuration message according to the first embodiment.

FIG. 12A to 12C are diagrams each illustrating an operation example according to the first embodiment.

FIG. 13 is a diagram illustrating an operation example according to the first embodiment.

FIG. 14 is a diagram illustrating an operation example according to the first embodiment.

FIG. 15 is a diagram illustrating an operation example according to the first embodiment.

FIG. 16 is a diagram illustrating an operation example according to the first embodiment.

FIG. 17 is a diagram illustrating an operation example according to the first embodiment.

FIG. 18 is a diagram illustrating an operation example according to the first embodiment.

FIG. 19 is a diagram illustrating an operation example according to the first embodiment.

FIG. 20 is a diagram illustrating an operation example according to the first embodiment.

FIG. 21 is a diagram illustrating an operation example according to the first embodiment.

FIG. 22 is a diagram illustrating an operation example according to the first embodiment.

FIG. 23 is a diagram illustrating an operation example according to the first embodiment.

FIG. 24 is a diagram illustrating an operation example according to the first embodiment.

### DESCRIPTION OF EMBODIMENTS

The present disclosure has an object to efficiently perform an LCM operation.

### First Embodiment

A mobile communication system according to a first embodiment will be described with reference to the drawings. In the description of the drawings, the same or similar parts are denoted by the same or similar reference signs.

### Configuration of Mobile Communication System

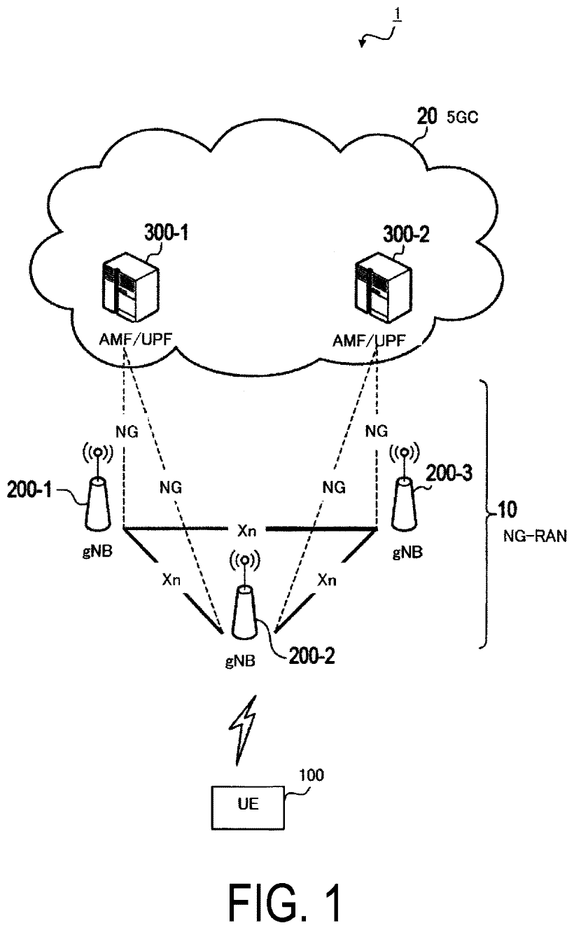

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20. Further, an apparatus included in the core network CN may be referred to as a core network apparatus.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20. The core network apparatus and the gNB 200 may collectively be referred to as a network apparatus.

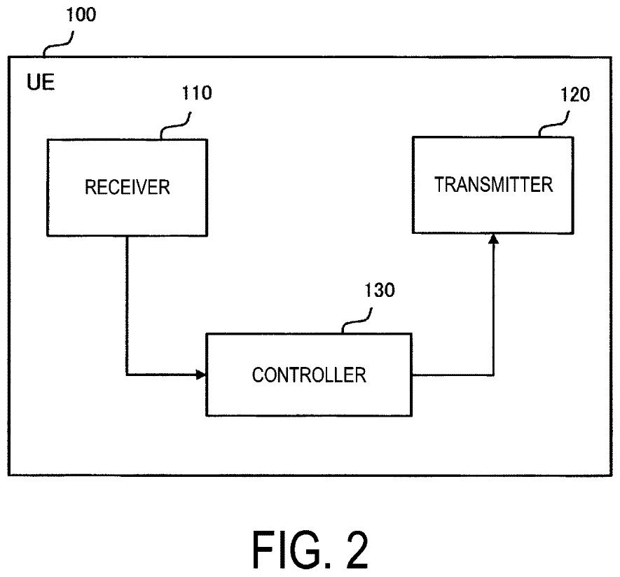

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described below. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

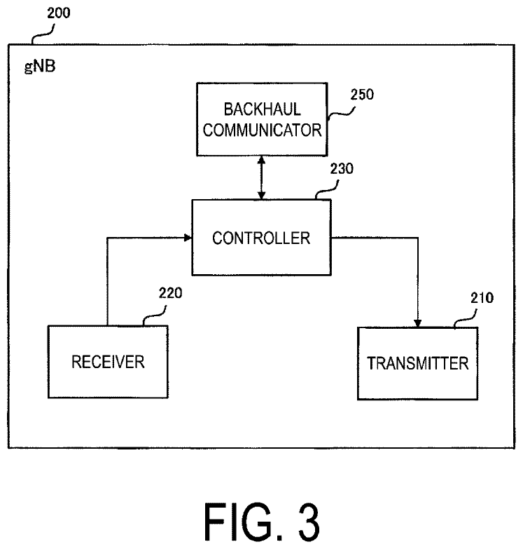

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described below. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

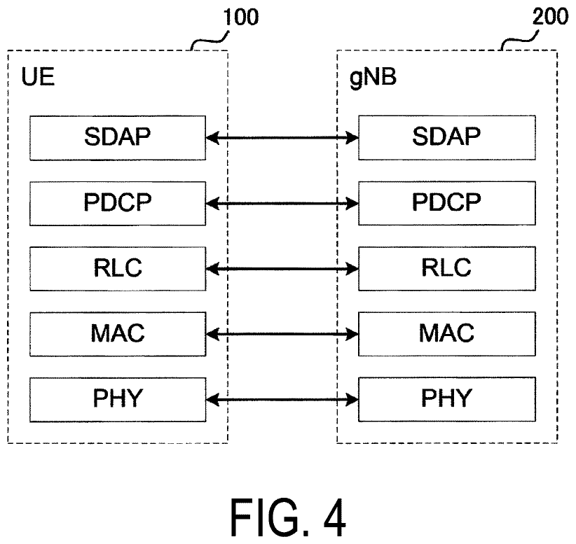

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When the plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and assigned resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

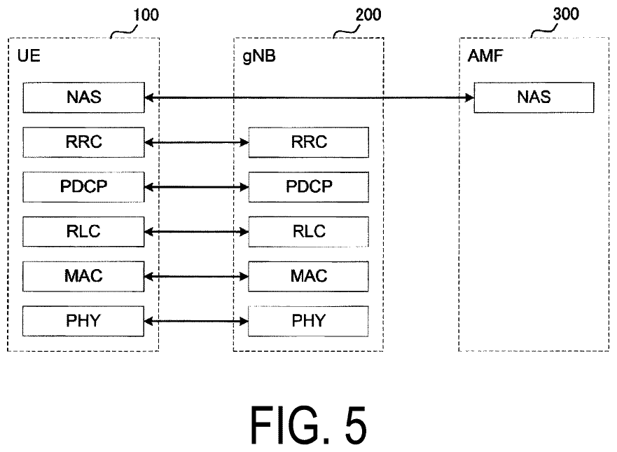

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

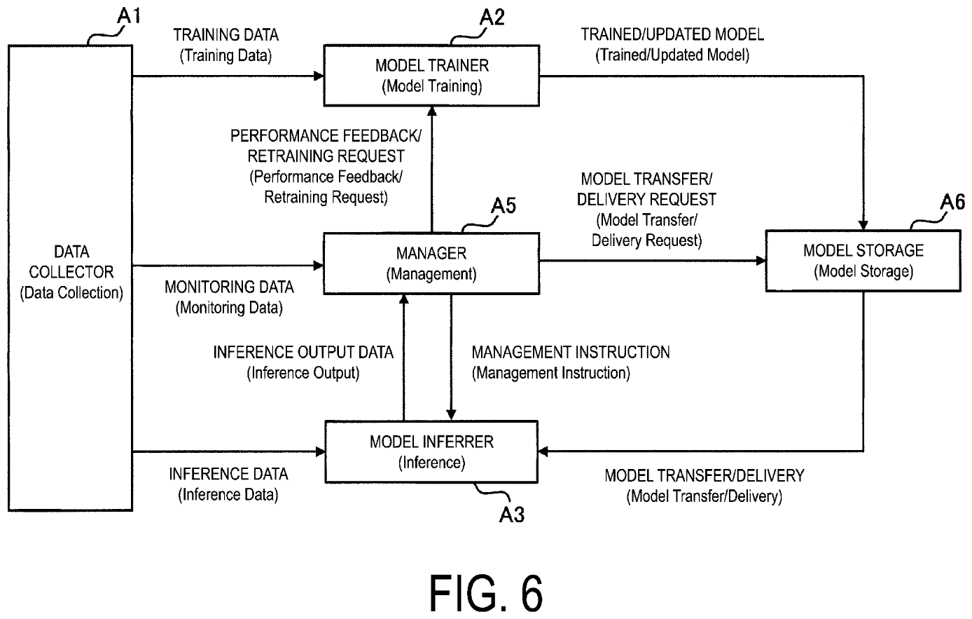

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector (Data Collection) A1, a model trainer (Model Training) A2, a model inferrer (Inference) A3, a manager (Management) A5, and a model storage (Model Storage) A6.

The functional block configuration example illustrated in FIG. 6 represents a functional framework of a typical AI/ML technology. Hence, a part of the functional block configuration example (for example, the model storage A6) may not be included in the functional block configuration example depending on a virtual use case. The functional block configuration example illustrated in FIG. 6 may be distributed and arranged in the UE 100 and a network-side apparatus. Alternatively, in the functional block configuration example, some functions (for example, the model trainer A2, the model inferrer A3, or the like) may be arranged in both the UE 100 and the network-side apparatus.

The data collector A1 supplies input data to the model trainer A2, the model inferrer A3, and the manager A5. The input data includes training data for the model trainer A2, inference data for the model inferrer A3, and monitoring data for the manager A5.

The training data is data necessary to input when the AI/ML model performs training. The inference data is data necessary to input when the AI/ML model performs inference. Further, the monitoring data is data necessary to input at the time of management of the AI/ML model.

Data collection refers to the process of collecting data by a network node, a management entity, or the UE 100 to perform training, management, and inference of the AI/ML model, for example.

The model trainer A2 performs AI/ML model training, AI/ML model validation, and AI/ML model testing.

The AI/ML model training is a process of causing an AI/ML model to perform training using an input and output relationship to obtain a trained AI/ML model for use in inference. For example, considering y=ax+b, the process of optimizing a (slope) and b (intercept) by giving an input (x) and an output (y) (i.e., giving training data) may be AI/ML model training.

In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model trainer A2 outputs the trained AI/ML model (Trained Model) obtained by the AI/ML model training to the model storage A6, and the model trainer A2 outputs an updated AI/ML model (Updated Model) obtained by retraining the trained AI/ML model to the model storage A6.

Hereinafter, the AI/ML model training may be referred to as a “model training” or “training”.

The model inferrer A3 performs AI/ML model inference. In particular, the model inferrer A3 applies inference data provided from the data collector A1 to the trained AI/ML model (or updated AI/ML model) to obtain inference output data (Inference Output). For example, considering y =ax +b, x corresponds to the inference data and y corresponds to the inference output data. Note that “y=ax+b” is an AI/ML model. A model in which a slope and an intercept are optimized, for example, “y=5×+3” is a trained AI/ML model. The model has various approaches, such as linear regression analysis, neural network, and decision tree analysis. The above “y=ax+b” can be considered as a type of linear regression analysis.

The model inferrer A3 outputs the inference output data to the manager A5. The model inferrer A3 accepts a management instruction from the manager A5. For example, the management instruction includes selection of an AI/ML model, activation (deactivation) of an AI/ML model, switching an AI/ML model, fallback (performing inference without using an AI/ML model). The model inferrer A3 performs model inference in accordance with the management instruction.

Note that an AI/ML model inference refers to a process of obtaining a set of outputs from a set of inputs by using a trained AI/ML model (or an updated AI/ML model), for example. Alternatively, the AI/ML model inference may be a process of obtaining inference output data from inference data by using a trained AI/ML model (or an updated AI/ML model). Hereinafter, the AI/ML model inference may be referred to as “model inference” or “inference”.

Hereinafter, an AI/ML model under training (or under updating) may be referred to as a training AI/ML model (or an updating AI/ML model). Hereinafter, when the AI/ML model under training (or under updating) is not distinguished from the trained (or updated) AI/ML model, both may simply be referred to as an “AI/ML model”.

The manager A5 oversees operations (selection, activation, deactivation, switching, fallback, and the like) on an AI/ML model. Further, the manager A5 oversees monitoring on an AI/ML model. The manager A5 can also perform an operation for ensuring an appropriate inference operation based on monitoring data and inference output data. Hence, the manager A5 outputs a model transfer and/or model delivery request (Model Transfer/Deliver Request) to the model storage A6, and causes a trained (or updated) AI/ML model stored in the model storage A6 to be output to the model inferrer A3. The manager A5 outputs a management instruction to the model inferrer A3, and oversees the operation on an AI/ML model. Further, the manager A5 may output performance feedback and a retraining request to the model trainer A2, and may cause the model trainer A2 to retrain the AI/ML model (i.e., update the trained AI/ML model).

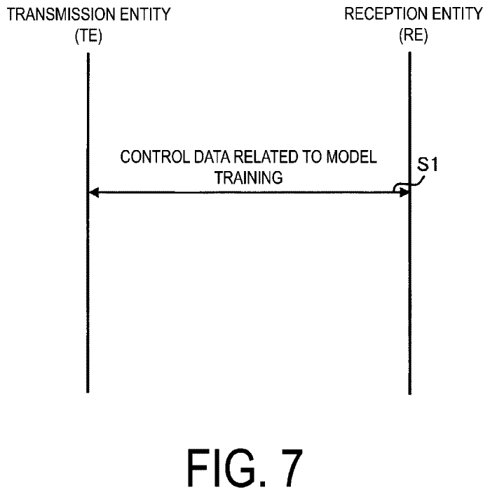

FIG. 7 is a diagram illustrating an operation example in the AI/ML technology according to the first embodiment.

In FIG. 7, a transmission entity TE is an entity that performs model inference and is capable of transmitting inference output data to a reception entity RE. On the other hand, the reception entity RE is an entity that is capable of receiving the inference output data from the transmission entity TE. The model training may be performed in the transmission entity TE. The model training may be performed in the reception entity RE. When the model training is performed at the reception entity RE, the trained AI/ML model may be transmitted from the reception entity RE to the transmission entity TE.

The entity may be, for example, an apparatus. The entity may be a functional block included in the apparatus. The entity may be, for example, a hardware block included in the apparatus.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (for example, an AI/ML layer) dedicated to artificial intelligence or machine learning. Alternatively, the control data may be a NAS message of a NAS layer.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.

(X1.1) “Channel State Information (CSI) feedback enhancement”

(X1.2) “Beam management”

(X1.3) “Positioning accuracy enhancement”

(X1.1) Arrangement example of functional blocks in “CSI feedback enhancement” is a s follows.

The “CSI Feedback Enhancement” represents, for example, a use case when an AI/ML technology is applied to a CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

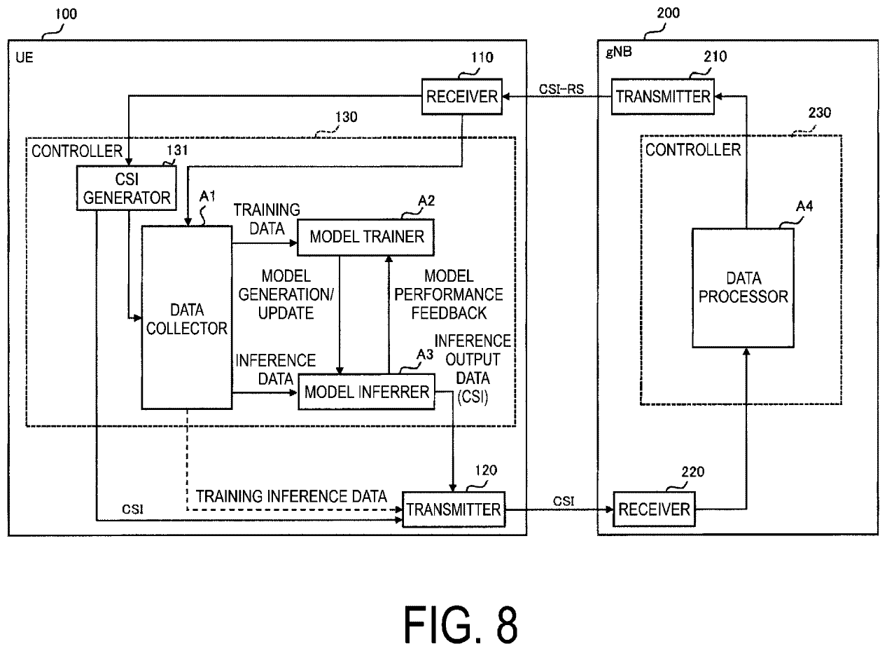

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal and CSI. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources, the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

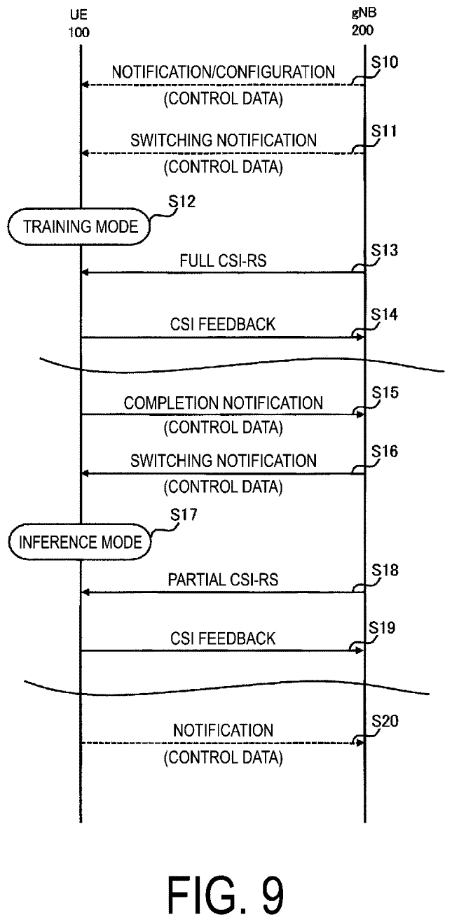

FIG. 9 is a diagram illustrating an operation example in the “CSI feedback enhancement” according to the first embodiment.

As illustrated in FIG. 9, in step S10, the gNB 200 may notify the UE 100 of or configure for the UE 100, a transmission pattern (punctured pattern) of the CSI-RS in the inference mode as control data. For example, the gNB 200 transmits, to the UE 100, antenna ports and/or time-frequency resources used or not used to transmit the CSI-RS in the inference mode.

In step S11, the gNB 200 may transmit a switching notification for causing the UE 100 to initiate a training mode.

In step S12, the UE 100 initiates the training mode.

In step S13, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 creates a trained AI/ML model with the full CSI-RS and the CSI as training data.

In step S14, the UE 100 transmits the generated CSI to the gNB 200.

Thereafter, in step S15, when the model training is completed, the UE 100 transmits a completion notification to the gNB 200, the completion notification indicating that the model training is completed. The UE 100 may transmit the completion notification when creation of the trained model is completed.

In step S16, the gNB 200 transmits to the UE 100 a switching notification for switching the UE 100 from the training mode to an inference mode in response to receiving the completion notification.

In step S17, the UE 100 switches from the training mode to the inference mode in response to receiving the switching notification.

In step S18, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S19, the UE 100 feeds back (or transmits) the CSI being an inference result as inference result data to the gNB 200. The UE 100 can generate a trained model with a predetermined accuracy or higher by repeating model training in the training mode. The inference result obtained by using the trained model generated as described above is expected to have a predetermined accuracy or higher.

Note that, in step S20, when determining by itself that the model training is necessary, the UE 100 may transmit a notification to the gNB 200 as control data, the notification indicating that the model training is necessary.

In the description of the example illustrated in FIG. 9, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.

(Y1) Reference Signals Received Power (RSRP), Reference Signal Received Quality (RSRQ), Signal-to-interference-plus-noise ratio (SINR), or an output waveform of an AD converter (the measurement target may be CSI-RS. The measurement target may be other reception signals received from the gNB 200)

(Y2) Bit error rate (BER) or block error rate (BLER) (BER (or BLER) may be measured based on CSI-RS with a total number of transmission bits (or a total number of transmission blocks) being known)

(Y3) Moving speed of the UE 100 (which may be measured by a speed sensor in the UE 100)

What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (Y1) to (Y3). The capability information may be information in which training data and inference data are separately designated. The gNB 200 transmits, to the UE 100 as the control data, the data type information used as a dataset. The data type information may represent, for example, any of data or information indicated in (Y1) to (Y3). As

### the data type information, data type information used as training data and data type information used as inference data may be separately designated.

Hereinbefore, there is described (X1.1) Arrangement example of functional blocks in “CSI Feedback Enhancement”. The above-described arrangement example is an example, and in 3GPP, an arrangement example of functional blocks is in a study stage. Further, (X1.2) “Beam management” and (X1.3) “Positioning accuracy enhancement” are also in a study stage.

### (X1.4) Model Transfer Example

Next, transfer of AI/ML model (Model Transfer) will be described. Note that the transfer of the AI/ML model and the delivery of the AI/ML model (Model Delivery) are described with the same meaning.

### (X1.4.1) First Operation Pattern Related to Model Transfer

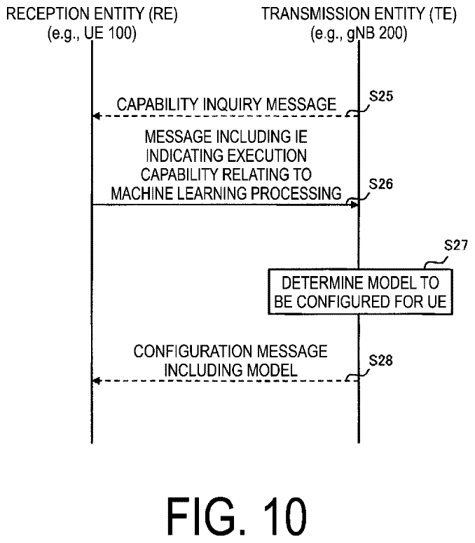

FIG. 10 is a diagram illustrating an operation example of a first operation pattern related to model transfer according to the first embodiment. In the example illustrated in FIG. 10, the reception entity RE is mainly described as the UE 100. However, the reception entity RE may be the gNB 200 or the AMF 300. In the example illustrated in FIG. 10, the transmission entity TE is described as the gNB 200. However, the transmission entity TE may be the UE 100 or the AMF 300.

As illustrated in FIG. 10, in step S25, the gNB 200 transmits, to the UE 100, a capability inquiry message for requesting transmission of a message including an information element (IE) indicating execution capability related to learning processing. The UE 100 receives the capability inquiry message. Note that the gNB 200 may transmit the capability inquiry message when performing (when determined to perform) the learning processing.

In step S26, the UE 100 transmits, to the gNB 200, a message including an information element indicating execution capability related to learning processing (execution environment related to learning processing from another viewpoint). The gNB 200 receives the message. The message may be an RRC message, (for example, a “UE Capability” message or a newly defined message (for example, a “UE AI Capability” message or the like)). Alternatively, the transmission entity TE may be the AMF 300 and the message may be a NAS message. Alternatively, when a new layer for performing or controlling the learning processing (AI/ML processing) is defined, the message may be a message of the new layer.

The information element indicating the execution capability related to the learning processing may be an information element indicating the capability of a processor for performing the learning processing and/or an information element indicating the capability of a memory for performing the learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability related to the learning processing may be an information element indicating the execution capability of inference processing (model inference). The information element indicating the execution capability of the inference processing may be, specifically, an information element indicating whether a deep neural network model can be supported. The information element may be an information element indicating the time (or response time) required to execute the inference processing.

Alternatively, the information element indicating the execution capability related to the learning processing may be an information element indicating the execution capability of the learning processing (model training). The information element indicating the execution capability of the learning processing may be, specifically, an information element indicating the number of simultaneous executions of the learning processing. The information element may be an information element indicating the processing capacity of the learning processing.

In step S27, the gNB 200 determines a model to be configured (or deployed) for the UE 100 based on the information element included in the message received in step S26.

In step S28, the gNB 200 transmits a message including a model determined in step S27 to the UE 100. The UE 100 receives the message and performs learning processing (i.e., model training processing and/or model inference processing) by using the model included in the message. A specific example of step S28 will be described in a second operation pattern below.

### (X1.4.2) Second Operation Pattern Related to Model Transfer

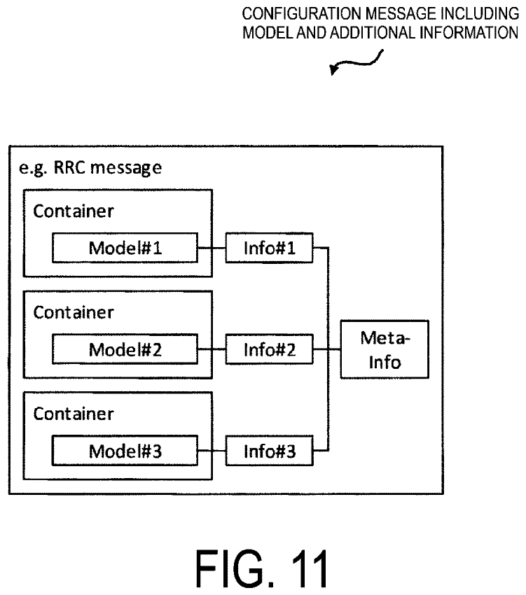

FIG. 11 is a diagram illustrating an example of a configuration message including a model and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 11, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### LCM According to First Embodiment

3GPP defines life cycle management (LCM) for an AI/ML technology. The LCM is, for example, managing an AI/ML model from generation to termination. Through such management, the mobile communication system 1 can appropriately operate an AI/ML model and appropriately support various use cases using the AI/ML model. The LCM includes, for example, the following elements.
(Z1) Data collection
(Z2) Model training
(Z3) Functionality/model identification
(Z4) Model delivery/model transfer
(Z5) Model inference operation
(Z6) Functionality/model selection, activation, deactivation, switching, and fallback
(Z7) Functionality/model monitoring
(Z8) Model update
(Z9) UE capability

Elements above may basically be executed over time. Note that it does not necessarily mean that the elements are strictly performed in the order above. For example, the model identification of (Z3) may be used to recognize which model is the target in each of the model training of (Z2), the model delivery of (Z4), and the model inference operation of (Z5).

In the following, each element included in the LCM may be referred to as an LCM operation. The LCM operation may be that each element is executed.

With respect to the LCM, 3GPP defines function-based LCM and model ID-based LCM. The function-based LCM can specify an AI/ML model in a unit of a function, for example. For example, specifying one function can specify one or more AI/ML models. In the function-based LCM, activation of an AI/ML function or the like can be instructed by using 3GPP signaling (for example, RRC, MAC-CE, DCI, or the like) from a network apparatus. On the other hand, in the model ID-based LCM, each AI/ML model can be specified by using a model ID. For example, in the model ID-based LCM, each AI/ML model is identified by a network apparatus, and an operation for each AI/ML model can be instructed through the model ID.

Note that the function-based LCM and the model ID-based LCM only differ in how to identify an AI/ML model. After the identification is performed for an AI/ML model, another operation related to the LCM may be performed through the same process.

In the first embodiment, description is made that the model ID-based LCM is applied in the mobile communication system 1. Note that, in the first embodiment, the function-based LCM may be applied to the mobile communication system 1.

### Model Identification According to First Embodiment

In the first embodiment, attention is paid to the model identification of (Z3) in the LCM. The model identification is, for example, to identify (or specify) an AI/ML model. For example, in the model training, the model identification is performed to identify which model is the training target. Alternatively, in the model inference, the model identification for identifying which model is the inference target may be performed. Alternatively, model identification may be performed to identify the AI/ML model to be the target of each operation such as a retraining request, a management instruction, and model transfer. The model identification is used in the model ID-based LCM. Hence, in the model identification, a model ID is used to identify an AI/ML model from other AI/ML models.

3GPP mainly classifies the model identification into Type A and Type B.

Type A is a type in which the AI/ML model is identified without radio signaling in the network apparatus or the UE 100. For example, when the trained AI/ML model is a model that is applicable to any scenario and is rarely updated, Type A is applicable. In the case above, both the network apparatus and the UE 100 can specify an AI/ML model without performing model identification. Note that, in Type A, although the model ID is assigned, the model ID is not used at the time of model identification, and the model ID is used after the model identification is performed.

On the other hand, in Type B, the AI/ML model is identified by using radio signaling. For example, when the trained AI/ML model is frequently updated, Type B is applicable to the trained AI/ML model. Alternatively, while Type A is initially applicable, Type B can be applicable when an update is performed for some reason. 3GPP further classifies Type B into Type B1 and Type B2.

In Type B1, the UE 100 initiates model identification and the network apparatus assists remaining steps of the model identification. On the other hand, in Type B2, the network apparatus initiates model identification and the UE 100 responds to the remaining steps of the model identification. Type B is classified into the two types based on where the model identification is initiated. Note that a model ID is assigned to both Type B1 and Type B2, and the model ID is used at the time of model identification.

### Proposal Example of Model Identification

In response to the above discussion on model identification, the following contribution (R1-2310999, 3GPP TSG-RAN WG1 Meeting #115, Chicago, USA, Nov. 13-Nov. 17, 2023) was submitted in 3GPP.

That is, in the above contribution, it is proposed that Type A (AI/ML model is identified without radio signaling) is performed in the following order.

(A1) Model ID is assigned offline.

(A2) Model ID and meta information are provided to a network apparatus without using radio signaling (if possible).

(A3) UE capability including model ID is updated.

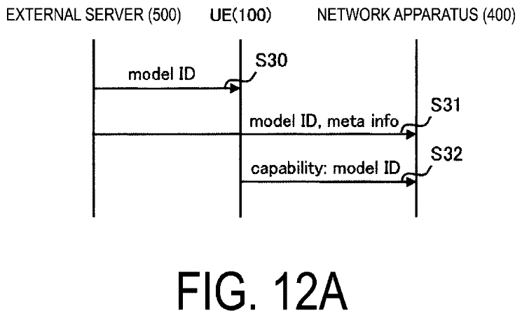

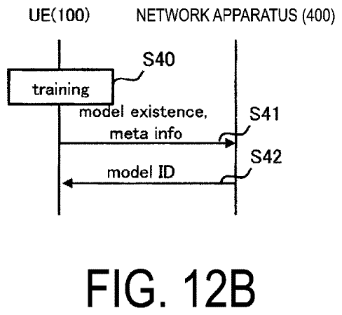

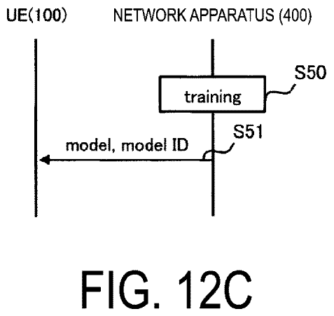

FIG. 12A is a diagram illustrating an operation example depicting the proposal of Type A. In FIG. 12A, the external server 500 is taken as an example of being offline. Being offline means that, for example, radio signaling defined in 3GPP is not used. Being offline may be a state not connected to a cellular network system of 3GPP. Hence, as an example of being offline, the external server 500 located outside the 3GPP cellular network system may be used.

As illustrated in FIG. 12A, the external server 500 transmits a model ID to the UE 100 (step S30), and transmits the model ID and meta information to the network apparatus 400 (step S31). Since the UE 100 can acquire the model ID offline without using radio signaling, step S30 corresponds to the above (A1). Similarly, step S31 corresponds to the above (A2) because the network apparatus 400 can acquire the model ID offline without using radio signaling. Further, step S32 corresponds to the above-described (A3).

When the UE 100 and the network apparatus 400 receive the model ID (step S30 and step S31), the model can be identified by using the model ID. The model identification in the UE 100 and the network apparatus 400 is possible at the time of step S30 and step S31, respectively. Hence, the condition of Type A that model identification is performed without using radio signaling is satisfied.

Further, in the above contribution, it is proposed that Type B1 (AI/ML model is identified by using radio signaling, and model identification is initiated by the UE 100) is performed in the following order.

(B1-1) The training of an AI/ML model is performed on a UE 100 side.

(B1-2) The presence of a new AI/ML model because of the above-described training, together with meta information, is provided to the UE 100 and the network apparatus.

(B1-3) The network apparatus assigns a model ID and provides the model ID to the UE 100.

FIG. 12B illustrates an operation example depicting the above proposal for Type B1. The UE 100 causes an AI/ML model to perform training (step S40, (B1-1)), and transmits the presence of a new AI/ML model and meta information to the network apparatus 400 (step S41, (B1-2)). The network apparatus 400, then, transmits a model ID to the UE 100 (step S42, (B1-3)). Type B1 differs from the other types in that model identification is initiated by the UE 100. The model identification illustrated in FIG. 12B starts from the model training in the UE 100 (step S40), and thus satisfies the condition of Type B1.

Further, it is proposed in the above contribution that Type B2 (AI/ML model is identified by using radio signaling and model identification is initiated by the network apparatus 400) is performed in the following order.

(B2-1) The training of a new AI/ML model is performed on a network apparatus side.

(B2-2) The network apparatus transfers the new AI/ML model together with the model ID to the UE 100.

FIG. 12C illustrates an operation example depicting the above proposal for Type B2 . The network apparatus 400 performs training of an AI/ML model (step S50, (B2-1)), and transmits a trained AI/ML model and a model ID to the UE 100 (step S51, (B2-2)). The model identification in FIG. 12C is also started from the model training (step S50) in the network apparatus 400, and thus satisfies the condition of Type B2.

### Communication Control Method According to First Embodiment

Here, the model identification proposed in the above contribution focuses on model identification in the LCM, and clearly indicates how an operation is performed in each type.

However, the model identification proposed in the above contribution may not necessarily be an efficient operation in view of the entire LCM operation. Hence, the entire LCM operation may not efficiently be performed.

Thus, the first embodiment has an object to make the LCM operation be efficiently performed. Hereinafter, a specific operation example will be described to explain how the LCM operation is efficiently performed. In particular, efficiency of the LCM operation will be explained in each operation example as follows. An operation example related to Type A (first operation example) will be described, an operation example related to Type B1 (second operation example) will be described, and finally an operation example related to Type B2 (third operation example) will be described.

### 1. First Operation Example (Operation Example of Type A)

In the first operation example, an operation example of Type A will be described. As described above, Type A is a type in which model identification is performed without using radio signaling. In the above contribution, it is proposed that Type A is performed by the operation described in the above (A1) to (A3) (or FIG. 12A).

Here, focusing on FIG. 12A again, the UE 100 only receives the model ID from the external server 500 (step S30). When performing model inference by itself, the UE 100 may not be able to actually perform the model inference with only the model ID, in consideration of the capability of the UE 100. When the model inference is performed in the network apparatus 400, the UE 100 may not be able to acquire inference data by itself, and consequently, may not be able to transmit inference data to the network apparatus 400 depending on the type of inference data used in the model inference.

Hence, in the first operation example, the UE 100 acquires meta information together with the model ID. Specifically, first, a user equipment (for example, the UE 100) acquires model identification information (for example, model ID) for identifying an AI/ML model and additional information (for example, meta information) of the AI/ML model. Second, the user equipment transmits the model identification information to a network apparatus (for example, the network apparatus 400). Third, in a case that the user equipment determines that the inference for the AI/ML model is possible based on the additional information when transmitting the model identification information, the user equipment transmits the model identification information.

As described above, in the first operation example, the UE 100 transmits the model ID to the network apparatus 400 when the UE 100 acquires the meta information together with the model ID and determines that the inference for the AI/ML model is possible based on the meta information. This makes it possible, in the first operation example, for the UE 100 to transmit the model ID when the model inference is possible, and not to transmit the model ID when the model inference is not possible. Thus, the UE 100 can efficiently perform subsequent LCM operations (for example, model inference).

The first operation example will be described in detail below. In the first operation example, three operation examples of a UE side model, a network side model, and a two-sided model will be described separately in consideration of a scene in which inference is performed.

Note that the UE side model is a model in which model inference is performed in the UE 100. The network side model is a model in which model inference is performed in the network apparatus 400. Further, the two-sided model is a model in which model inference is performed both in the UE 100 and in the network apparatus 400.

### 1.1. (1-1)-th Operation Example

In the present operation example, with respect to Type A, there will be described an operation example when model inference is performed on the UE 100 side (UE side model).

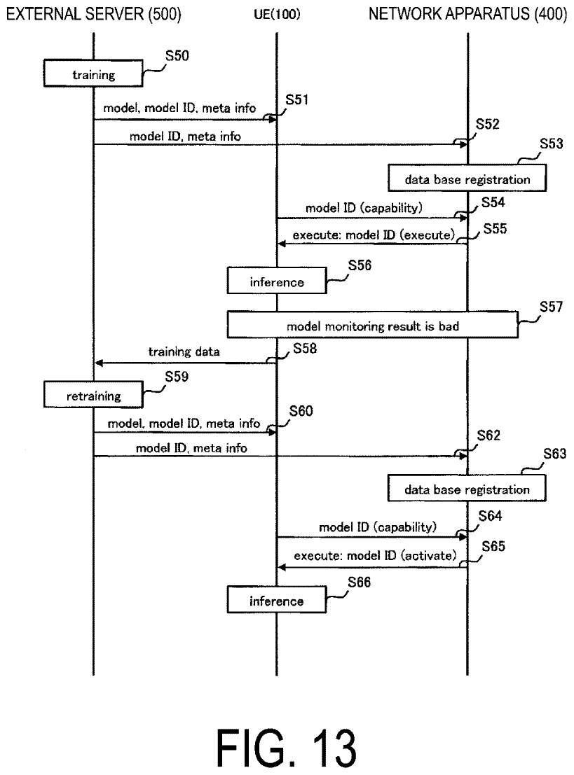

FIG. 13 is a diagram illustrating the (1-1)-th operation example according to the first embodiment. In FIG. 13, an external server 500 is illustrated as an example of being offline in accordance with the above contribution. The external server may be an over-the-top (OTT) server. Note that the external server 500 may be replaced with an access point of a wireless local area network (LAN), a portable memory (for example, a memory card), or the like.

As illustrated in FIG. 13, in step S50, the external server 500 performs model training. For example, model training is performed in the external server 500 in consideration of resources or the like in the UE 100. In the UE 100, model training does not have to be performed, and thus resources can be reduced as compared with a case that model training is performed.

In step S51, the UE 100 acquires a trained AI/ML model, a model ID of the trained AI/ML model, and meta information of the trained AI/ML model. In the example of FIG. 13, the receiver 110 of the UE 100 receives the trained AI/ML model, the model ID, and the meta information from the external server 500 to acquire them. That is, the UE 100 acquires the trained AI/ML model, the model ID, and the meta information offline.

Here, when step S30 in FIG. 12A is compared with step S51, the UE 100 receives the meta information in addition to the model ID. Now, the meta information will be described.

The meta information may include the type of inference data used for model inference and/or the type of inference output data. The controller 130 of the UE 100 checks whether the inference data can be acquired by checking the type of the inference data and/or the inference output data based on the meta information, and thus can determine whether the model inference can be performed.

Alternatively, the meta information may include an application condition to which a trained AI/ML model used for the model inference is applied.

First, the application condition may represent a position where model inference is feasible. The position may be represented by a cell, a RAN based notification area (RNA), a tracking area (TA), a public land mobile network (PLMN), or the like. Alternatively, the position may be represented by latitude and longitude acquired by a global navigation satellite system (GNSS) function. The controller 130 of the UE 100 compares the current position of itself with the position where model inference is feasible to determine whether the UE 100 is in a position where the model inference is feasible, and thus whether the model inference is feasible can be determined.

Second, the application condition may be represented by a calculation capability required when model inference is performed. The controller 130 can determine whether the model inference is possible based on the calculation capability.

Third, the application condition may be represented by a memory capacity required when the model inference is performed. The controller 130 can determine whether the model inference is feasible based on the memory capacity.

Alternatively, the meta information may include information on a use case. As described above, examples of the use case include CSI feedback, positioning accuracy enhancement, beam management. Since there is a case that the controller 130 of the UE 100 cannot perform the model inference depending on a use case, whether the model inference is feasible can be determined based on information on the use case.

Alternatively, the meta information may include version information of the trained AI/ML model used for the model inference. For example, since model inference using an AI/ML model of a specific version could not be performed in the past, the controller 130 can determine whether to perform the model inference based on the version information.

Alternatively, the meta information may include model pairing information. For example, in a case of the two-sided model, the UE 100 and the network apparatus 400 may jointly perform the model inference by using different trained AI/ML models, respectively. In the case above, information indicating which AI/ML model is used in the UE 100 and the network apparatus 400 is represented as the model pairing information. The model pairing information may be represented by associating the model ID of the AI/ML model used in the UE 100 with the model ID of the AI/ML model used in the network apparatus 400. The controller 130 recognizes whether the controller 130 itself has the AI/ML model based on the pairing information, thereby being able to determine whether to perform model inference.

In step S52, the network apparatus 400 (for example, the receiver 220 of the gNB 200) acquires the model ID and the meta information. The model ID and the meta information may be identical to the model ID and the meta information of step S51, respectively. In the example of FIG. 13, when the network apparatus 400 is the gNB 200, the receiver 220 of the gNB 200 receives the model ID and the meta information from the external server 500, thereby acquiring the model ID and the meta information.

In step S53, the network apparatus 400 (for example, the controller 230 of the gNB 200) stores the model ID and the meta information in a database (or a memory).

In step S54, when the controller 130 of the UE 100 determines that model inference is feasible based on the meta information, the transmitter 120 of the UE 100 transmits the model ID to the network apparatus 400. The transmitter 120 of the UE 100 may transmit control data including the model ID (FIG. 7) to the gNB 200. The network apparatus 400 (for example, the receiver 220 of the gNB 200) receives the model ID.

In step S55, the network apparatus 400 (for example, the transmitter 210 of the gNB 200), in response to the reception of the model ID (step S54), transmits an instruction to perform the model inference using the trained AI/ML model to the UE 100 designating the model ID. The network apparatus 400 may transmit control data including the instruction to perform (FIG. 7) to the UE 100. The receiver 110 of the UE 100 receives the instruction to perform.

In step S56, the controller 130 of the UE 100 performs model inference in accordance with the instruction to perform.

In step S57, the controller 130 of the UE 100 detects that the result of the model inference is according to expectation or worse. The controller 130 may determine that the result of the model inference is according to expectation or worse when the inference output data is equal to or less than a threshold value. The network apparatus 400 (for example, the controller 230 of the gNB 200) may perform the detection.

In step S58, the controller 130 of the UE 100 determines to perform retraining, and the transmitter 120 transmits training data to the external server 500 for retraining.

The external server 500 performs retraining of the trained AI/ML model based on the training data (step S59).

In step S60, the receiver 110 of the UE 100 receives (or acquires) an updated AI/ML model updated by retraining, the model ID of the updated AI/ML model, and meta information of the updated AI/ML model from the external server 500. The controller 130 of the UE 100 determines whether the model inference using the updated AI/ML model is possible based on the meta information, in a way similar to step S51. The meta information may be identical to the meta information of step S51, with only difference that the target is the updated AI/ML model.

In step S62, the network apparatus 400 receives (or acquires) the model ID of the updated AI/ML model and the meta information of the updated AI/ML model from the external server 500. The meta information may be identical to the meta information of step S60.

Thereafter, step S63 to step S66 are the same as step S53 to step S56, respectively, except that the target of the model inference is the updated AI/ML model.

### 1.2. (1-2)-th Operation Example

In the (1-2)-th operation example, with respect to Type A, an operation example when model inference is performed on the network apparatus 400 side (network side model) will be described. The present operation example will describe mainly on differences from the (1-1)-th operation example (FIG. 13).

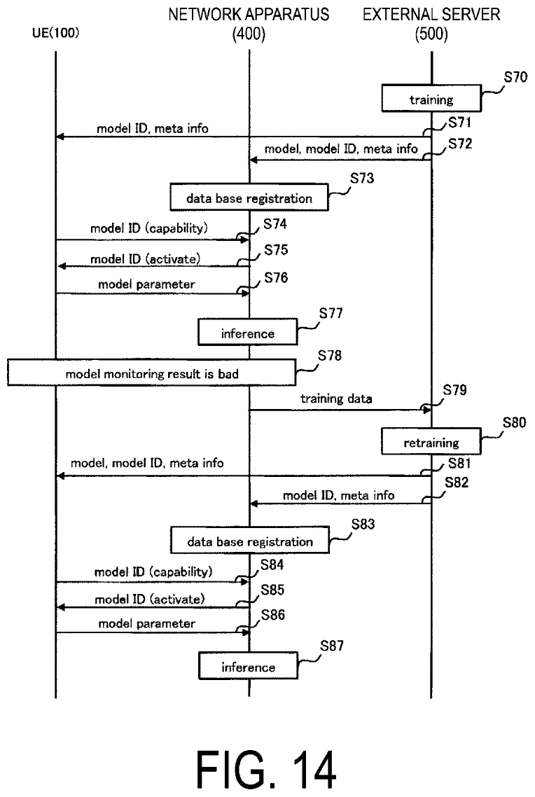

FIG. 14 is a diagram illustrating the present operation example according to the first embodiment.

Step S70 to step S73 are the same as step S50 to step S53 of the (1-1)-th operation example, respectively.

In step S71, the controller 130 of the UE 100 determines whether inference on the trained AI/ML model can be performed in response to the reception of the meta information in a way similar to the first operation example, but in this case, model inference is actually performed in the network apparatus 400. Hence, in the present operation example, the controller 130 determines whether the parameter (i.e., the inference data) used for the model inference can be acquired based on the meta information. The network apparatus 400 performs model inference by using the model parameter. Here, the meta information includes the type of data used in the trained AI/ML model. Hence, the controller 130 of the UE 100 can recognize the type of the model parameter based on the meta information. Accordingly, the controller 130 determines whether the model parameter can actually be acquired based on the meta information, and when it is determined that the model parameter can be acquired, the transmitter 120 of the UE 100 may transmit the model ID (step S74).

As described above, also in the present operation example, the controller 130 can determine whether the model parameter used for the model inference can be acquired based on the meta information. When determining that the model parameter can be acquired, the UE 100 transmits the model ID (step S74). Thus, the UE 100 can efficiently perform subsequent LCM operations (for example, model inference).

In step S74, when the controller 130 determines that the model parameter can be acquired (or the model inference can be performed), the transmitter 120 of the UE 100 transmits the model ID to the network apparatus 400. The transmission of the model ID itself may be performed by using the control data in a way similar to the (1-1)-th operation example.

In step S75, the network apparatus 400 (for example, the transmitter 210 of the gNB 200) determines that the model parameter can be acquired by the UE 100 in response to the reception of the model ID, and transmits an instruction to perform the model inference to the UE 100 designating the model ID. The instruction to perform the model inference may also be transmitted by using control data. The receiver 110 of the UE 100 receives the instruction to perform.

In step S76, the controller 130 of the UE 100 acquires the model parameter in response to the reception of the instruction to perform, and the transmitter 120 of the UE 100 transmits the acquired model parameter to the network apparatus 400 (step S76). The model parameter may be transmitted by using the control data. The model parameter may be transmitted by using a user plane (user data). The network apparatus 400 (for example, the receiver 220 of the gNB 200) receives the model parameter.

In step S77, the network apparatus 400 (for example, the controller 230 in the gNB 200) performs model inference by using the model parameter. In step S78, when the network apparatus 400 (for example, the controller 230 of the gNB 200) detects that the inference result is according to expectation or worse, the network apparatus 400 (for example, the transmitter 210 of the gNB 200) transmits the training data for retraining to the external server 500 in step S79. The subsequent processing operations (step S80 to step S87) are the same as step S70 to step S77, respectively, except that the target is the updated AI/ML model.

### 1.3. (1-3)-th Operation Example

In the present operation example, with respect to Type A, there will be described an operation example when model inference is performed on both the UE 100 side and the network apparatus 400 side (two-sided model). Note that, the present (1-3) operation example will describe two operation examples separately, the two operation examples of a case that inference is performed by using the same AI/ML model in the UE 100 and the network apparatus 400 and a case that inference is performed by using different AI/ML models in the UE 100 and the network apparatus 400.

### 1.3.1. (1-3-1)-th Operation Example

In the present operation example, there will be described an operation example when inference is performed by using the same AI/ML model in the UE 100 and the network apparatus 400 in the (1-3)-th operation example.

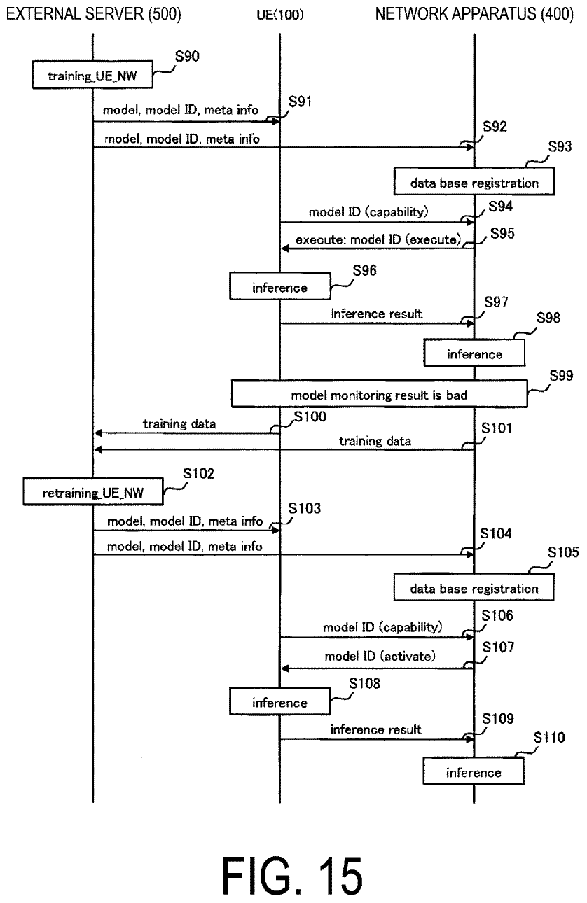

FIG. 15 illustrates an operation example according to the first embodiment. The following describes the differences between the present operation example and the (1-1)-th operation example (FIG. 13).

First, model inference is performed in both the UE 100 and the network apparatus 400 (step S96 and step S98). At this time, the model inference is performed in the UE 100 (step S96) first, the inference result (inference output data) is transmitted from the UE 100 to the network apparatus 400 (step S97), and then model inference is performed in the network apparatus 400 by using the inference result (step S98).

Second, the UE 100 and the network apparatus 400 having an identical trained AI/ML model as a target (step S90) differs from the (1-1)-th operation example. Using an identical trained AI/ML model is expressed as “UE_NW” in FIG. 15. Other than the above, the operation is the same as that of the (1-1)-th operation example.

### 1.3.2. (1-3-2)-th Operation Example

Next, the present operation example will be described. The present operation example is an operation example when inference is performed by using different AI/ML models in the UE 100 and the network apparatus 400 in the (1-3)-th operation example.

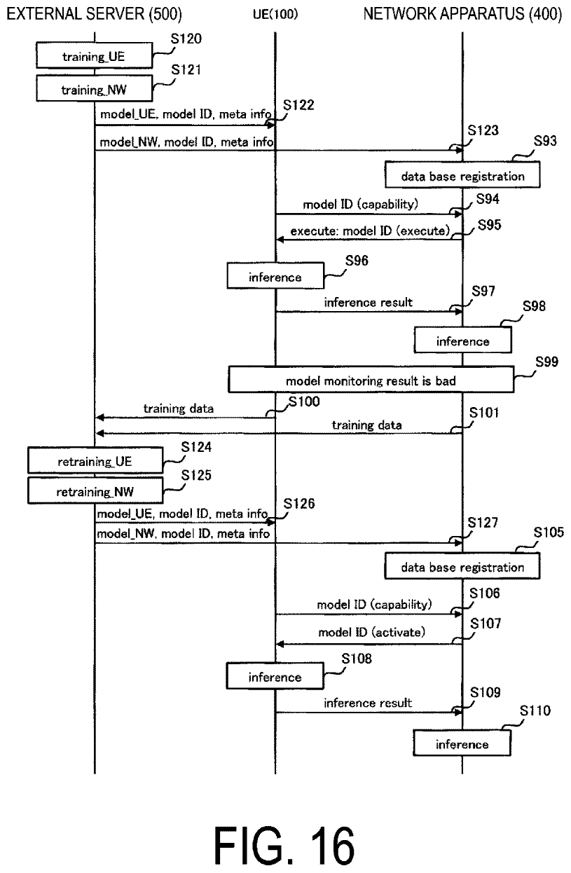

FIG. 16 is a diagram illustrating an operation example according to the first embodiment. The present operation example will be described mainly on differences from the (1-3-1)-th operation example (FIG. 15).

First, the present operation example is different from the (1-3-1)-th operation example in that the target of model training is the AI/ML model (step S120) used on the UE 100 side and the AI/ML model (step S121) used in the network apparatus 400 side. Hence, the receiver 110 of the UE 100 receives the trained AI/ML model used on the UE 100 side, the model ID of the trained AI/ML model, and the meta information of the trained AI/ML model (step S122). Further, the network apparatus 400 (for example, the receiver 220 of the gNB 200) receives the trained AI/ML model used on the network apparatus 400 side, the model ID of the trained AI/ML model, and the meta information of the trained AI/ML model (step S123).

Second, with respect to the meta information, the content of the meta information received by the UE 100 and the content of the meta information received by the network apparatus 400 are different from each other. That is, the meta information received by the UE 100 is meta information on the trained AI/ML model for the UE 100, and the meta information received by the network apparatus 400 is meta information on the trained AI/ML model for the network apparatus 400. The types of information included in the meta information may be the same.

Third, the present operation example is different in that the target of retraining is the trained AI/ML model used on the UE 100 side (step S124) and the trained AI/ML model used on the network apparatus 400 side (step S125). The subsequent processing operations (step S126 to step S110) are the same as those of step S122 to step S98 before update, respectively, except that the target is the updated AI/ML model.

Other than the above, the present operation example is the same as the (1-3-1)-th operation example.

### 2. Second Operation Example (Operation Example of Type B1)

Next, a second operation example will be described. In the second operation example, an operation example of Type B1 will be described. As described above, Type B1 is a type in which the model ID is identified by using radio signaling and the model identification is initiated by the UE 100. In the above contribution, it is proposed that Type B1 is performed by the operations described in the above (B1-1) to (B1-3) (FIG. 12B).

Here, focusing on FIG. 12B again, the UE 100 only transmits the presence of a trained AI/ML model newly created with model training (step S40) and meta information of the trained AI/ML model to the network apparatus 400 (step S41). For example, as seen in the two-sided model, when model training is performed in the network apparatus 400 in addition to the UE 100, training data is necessary at the time of model training, and there is a case that model training cannot appropriately be performed only with the presence of the model and the meta information. Even when the UE 100 receives the model ID from the network apparatus 400, the model ID may not be appropriate because the network apparatus 400 does not appropriately perform model training. Hence, the UE 100 may be notified of an additional message by the network apparatus 400. That is, FIG. 12B may not be an appropriate model identification operation in consideration of the entire LCM operation.

Hence, in the second operation example, the UE 100 transmits a parameter for training (i.e., training data), instead of transmitting the presence of the model, to the network apparatus 400. That is, first, the user equipment (for example, the UE 100) causes the AI/ML model to perform training. Second, the user equipment transmits the parameter used for training and additional information (for example, meta information) of the AI/ML model to the network apparatus (for example, the network apparatus 400). Third, in the network apparatus, training of the AI/ML model is performed by using the parameter.

As described above, in the second operation example, the UE 100 transmits the parameter for training to the network apparatus 400, and thus the network apparatus 400 can appropriately perform model training. The UE 100, then, can receive the appropriate model ID from the network apparatus 400. Accordingly, the LCM operation can efficiently be performed because the UE 100 does not send additional message to the network apparatus 400.

The second operation example will be described in detail below. In the second operation example, in a way similar to the first operation example, the UE side model and the two-sided model will be described separately in consideration of a scene in which inference is performed.

### 2.1. (2-1)-th Operation Example

In the present operation example, with respect to Type B1 (model ID is identified by using radio signaling and model identification is initiated by the UE 100), there will be described an operation example when model inference is performed on the UE 100 side (i.e., the UE side model).

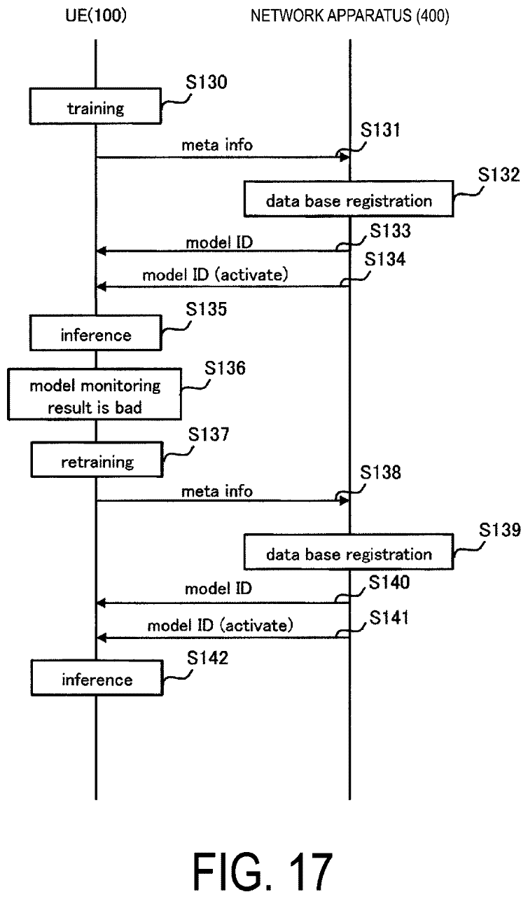

FIG. 17 is a diagram illustrating the present operation example according to the first embodiment.

As illustrated in FIG. 17, in step S130, the controller 130 of the UE 100 performs model training. The controller 130 generates a trained AI/ML model with model training. Step S130 represents Type B1 in which the model identification is initiated by the UE 100 side.

In step S131, the transmitter 120 of the UE 100 transmits the meta information of the trained AI/ML model to the network apparatus 400. The transmitter 120 may transmit the meta information by using the control data (FIG. 7). When compared with FIG. 12B, the UE 100 can effectively use a radio resource because it is not necessary to transmit information indicating that the trained AI/ML model is present to the network apparatus 400. The content of the meta information may be the same as in the first embodiment. The network apparatus 400 (for example, the receiver 220 of the gNB 200) receives the meta information.

In step S132, the network apparatus 400 (for example, the controller 230 of the gNB 200) stores the meta information in the memory.

In step S133, the network apparatus 400 (for example, the transmitter 210 of the gNB 200) transmits the model ID to the UE 100. The model ID may be transmitted by using the control data (FIG. 7).

In step S134, the network apparatus 400 transmits an instruction to perform model inference using the trained AI/ML model to the UE 100 designating the model ID. For example, the transmitter 210 of the gNB 200 may transmit control data including the instruction to perform to the UE 100. The receiver 110 of the UE 100 receives the instruction to perform.

In step S135, the controller 130 of the UE 100 performs model inference in accordance with the instruction to perform.

In step S136, the controller 130 of the UE 100 detects that the result of the model inference is according to expectation or worse. The detection itself may be the same as that in the first operation example.

In step S137, the controller 130 of the UE 100 determines to perform retraining, and retrains the trained AI/ML model. The controller 130 generates an updated AI/ML model by retraining.

Thereafter, step S138 to step S142 are the same as step S131 to step S135, respectively, except that the target is the updated AI/ML model.

### 2.2. Operation Example of Type B1 and Two-Sided Model

Next, with respect to Type B1, an operation example of the two-sided model will be described. In the present operation example, four operation examples in total will be described. There will be described two operation examples in which model training is performed on the UE 100 side and model training is not performed on the network apparatus 400 side (hereinafter, may be referred to as “a case that model training is performed only on the UE 100 side”) and two operation examples in which model training is performed on both the UE 100 side and the network apparatus 400 side.

### 2.2.1. Operation Example When Model Training Is Performed Only on UE 100 Side

First, two operation examples when model training is performed only on the UE 100 side will be described. In the present operation example, there will be described two operation examples of a case that the trained AI/ML model used for model inference is identical (or common) between the UE 100 and the network apparatus 400 and a case that the trained AI/ML model used for model inference is different between the UE 100 and the network apparatus 400.

### 2.2.1.1. When Identical Trained AI/ML Model is Used

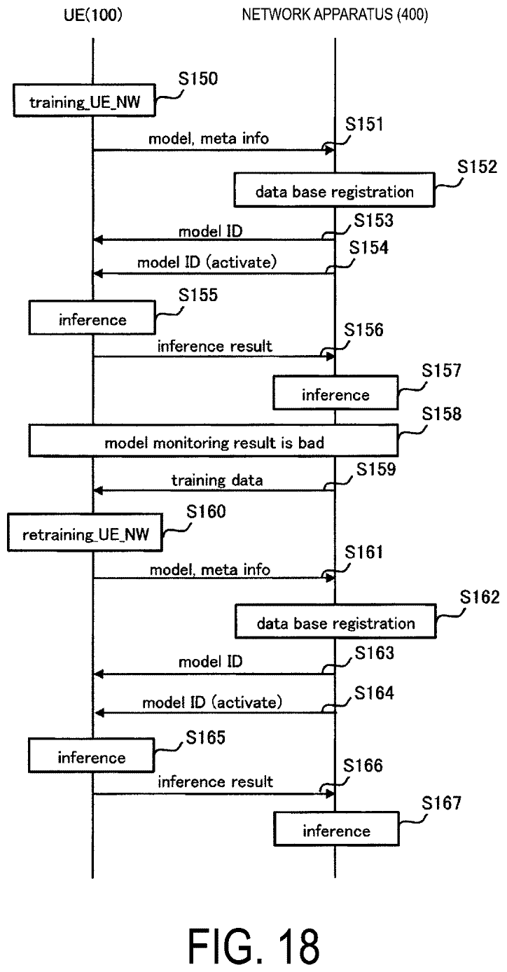

FIG. 18 illustrates an operation example when an identical trained AI/ML model is used. That is, FIG. 18 illustrates an operation example of a case of Type B1, the two-sided model (identical trained AI/ML model), and when model training is performed only on the UE 100 side. Hereinafter, the present operation example may be referred to as the (2-2-1-1)-th operation example for convenience.

The following describes the differences between the present operation example and the (2-1)-th operation example (FIG. 17).

First, the present operation example is different from the (2-1)-th operation example in that the present operation example is the two-sided model. That is, the controller 130 of the UE 100 performs model inference (step S155). The transmitter 120 of the UE 100, then, transmits the inference result (inference output data) to the network apparatus 400, and the network apparatus 400 (for example, the controller 230 of the gNB 200) performs model inference by using the inference result (step S157).

Second, in the present operation example, the transmitter 120 of the UE 100 transmits a trained AI/ML model, together with meta information, to the network apparatus 400 (step S151). The trained AI/ML model may be transmitted in the user plane. The trained AI/ML model may be transmitted by using the control data. The network apparatus 400 (for example, the controller 230 of the gNB 200) performs model inference by using the trained AI/ML model (step S157).

Third, the target for which model training, model inference, and retraining are performed is the identical AI/ML model (“UE_NW”) in the UE 100 and the network apparatus 400. Hence, the controller 130 of the UE 100 performs model training and generates a trained AI/ML model (“UE_NW”) used in both the UE 100 and the network apparatus 400 (step S150). Further, the UE 100 and the gNB 200 perform model inference by using the identical trained AI/ML model (step S155 and step S157). Further, the controller 130 of the UE 100 performs retraining, generates an updated AI/ML model (“UE_NW”) used in both the UE 100 and the network apparatus 400 (step S160), and performs model inference by using the updated AI/ML model (step S165 and step S167).

Other than the above, the present operation example is the same as the (2-1)-th operation example.

### 2.2.1.2. When Different Trained AI/ML Models Are Used

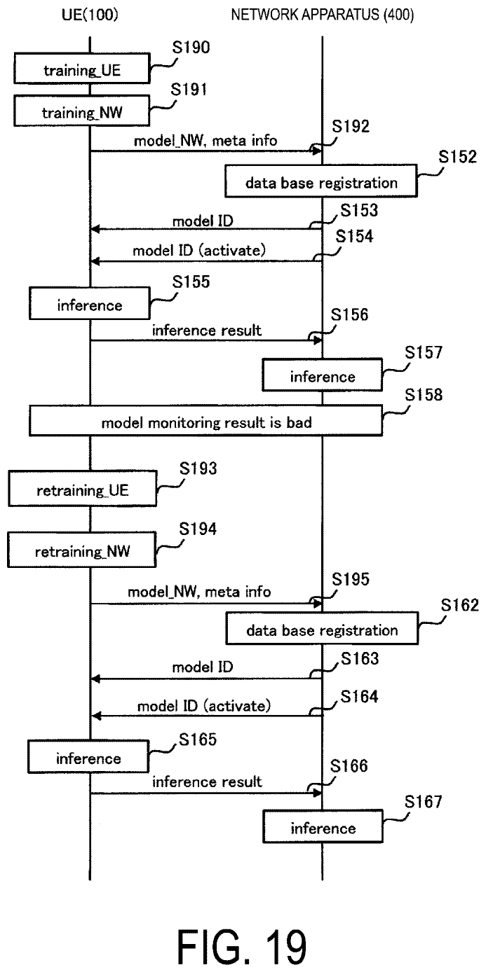

FIG. 19 illustrates an operation example when different trained AI/ML models are used. That is, FIG. 19 illustrates an operation example of a case of Type B1, the two-sided model (different AI/ML models), and when the model training is performed only on the UE 100 side. Hereinafter, the present operation example may be referred to as the (2-2-1-2)-th operation example for convenience.

The following describes the differences between the present operation example and the (2-1-1-1)-th operation example (FIG. 18).

First, the difference is that the target of model training and retraining is divided into the AI/ML model for the UE 100 and the AI/ML model for the network apparatus 400. Hence, the controller 130 of the UE 100 separately performs the model training of the AI/ML model for the UE 100 and the model training of the AI/ML model for the network apparatus 400 (step S190 and step S191). The transmitter 120 of the UE 100 transmits the trained AI/ML model (“model_NW”) for the network apparatus 400 to the network apparatus 400 (step S192). Further, the controller 130 separately performs retraining of the trained AI/ML model for the UE 100 and retraining of the trained AI/ML model for the network apparatus 400 (step S193 and step S194).

Second, the difference is that the processing targets are the AI/ML model for the UE 100 and the AI/ML model for the network apparatus 400. For example, the network apparatus 400 transmits an instruction to perform model inference to the UE 100 designating the model ID (step S153), but the target of the instruction to perform the model inference is the trained AI/ML model for the UE 100.

### 2.2.2. When Model Training Is Performed in Both UE 100 and Network Apparatus 400

Next, there will be described two operation examples when model training is performed in both the UE 100 and the network apparatus 400. In the present operation example as well, there will be described two operation examples of a case that the trained AI/ML model used for model inference is identical (or common) between the UE 100 and the network apparatus 400 and a case that the trained AI/ML model used for model inference is different between the UE 100 and the network apparatus 400.

### 2.2.2.1. When Identical Trained AI/ML Model Is Used

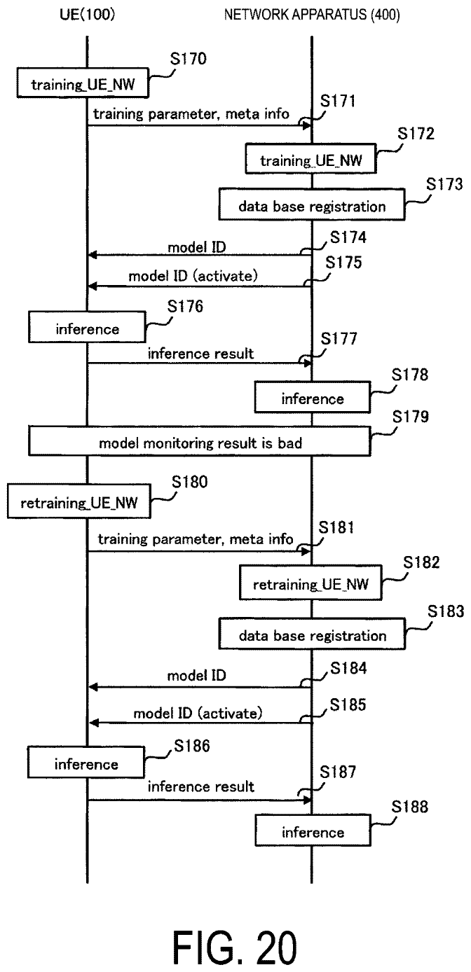

FIG. 20 illustrates an operation example when the identical trained AI/ML model is used. That is, FIG. 20 illustrates an operation example of a case of Type B1, the two-sided model (identical AI/ML model), and when model training is performed in both the UE 100 and the network apparatus 400. Hereinafter, the present operation example may be referred to as the (2-2-2-1)-th operation example for convenience.

The following describes the differences between the present operation example and the (2-2-1-1)-th operation example (FIG. 18).

First, in the present operation example, model training is performed also in the network apparatus 400 (step S172). For that, the transmitter 120 of the UE 100 transmits a training parameter (training data) and meta information to the network apparatus 400 (step S171). Since the identical trained AI/ML model is used in the UE 100 and the network apparatus 400, the training parameter used when the UE 100 has performed model training may be transmitted. The transmitter 120 may transmit the training parameter and the meta information by using the control data. Retraining is performed also in the network apparatus 400 (step S182), and the transmitter 120 of the UE 100 transmits the training parameter for the retraining and the meta information to the network apparatus 400 (step S181). The training parameter identical to the training parameter used for retraining by the UE 100 itself may be transmitted as the training parameter for retraining to the network apparatus 400.

Second, in the present operation example, the network apparatus 400 does not transmit the training data to the UE 100. Since the network apparatus 400 also performs model training, the training data does not need to be transmitted to the UE 100.

Other than the above, the present operation example is the same as the (2-2-1-1)-th operation example (FIG. 18).

### 2.2.2.2. When Different Trained AI/ML Models Are Used

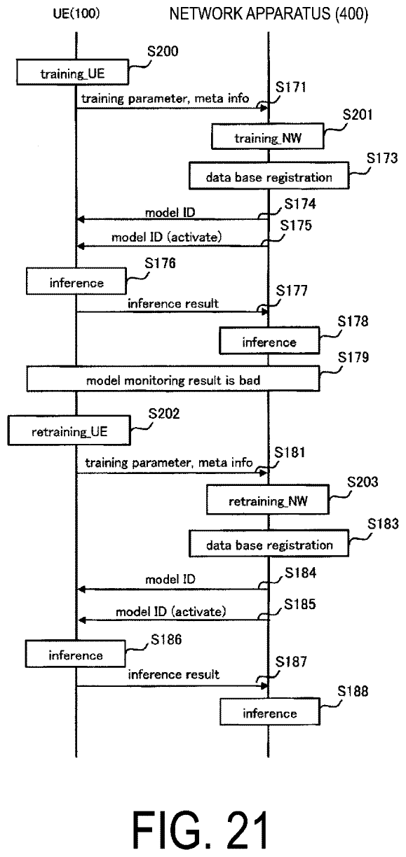

FIG. 21 illustrates an operation example when different AI/ML models are used. That is, FIG. 21 illustrates an operation example of a case of Type B1, the two-sided model (different AI/ML models), and when model training is performed in both the UE 100 and the network apparatus 400. Hereinafter, the present operation example may be referred to as the (2-2-2-2)-th operation example for convenience.

The following describes the differences between the present operation example and the (2-2-2-1)-th operation example (FIG. 20).

First, the target of model training differs between the UE 100 and the network apparatus 400. That is, the UE 100 performs model training of the AI/ML model for the UE 100 (step S200), and the network apparatus 400 performs model training of the AI/ML model for the network apparatus 400 (step S201). For that, the transmitter 120 of the UE 100 may transmit the training parameter to be used by the network apparatus 400 to the network apparatus 400, instead of the training parameter used by itself (step S171). With respect to the target to perform retraining as well, the UE 100 and the network apparatus 400 have different AI/ML models as targets (step S202 and step S203).

Second, the difference is that the processing targets are the AI/ML model for the UE 100 and the AI/ML model for the network apparatus 400. For example, the network apparatus 400 transmits an instruction to perform model inference to the UE 100 designating the model ID (step S174), but the target of the instruction to perform is the trained AI/ML model for the UE 100. The same applies to the retraining (step S184 and step S185).

Other than the above, the present operation example and the (2-1-2-1)-th operation example are basically the same.

### 3. Third Operation Example (Operation Example of Type B2)

Next, the third operation example will be described. In the third operation example, an operation example of Type B2 will be described. As described above, Type B2 is a type in which the model ID is identified by using radio signaling and model identification is initiated by the network apparatus 400. In the above contribution, it is proposed that Type B2 is performed by the operations described in the above (B2-1) to (B2-3) (FIG. 12C).

Here, focusing on FIG. 12C again, the network apparatus 400 transmits the trained AI/ML model itself generated by the model training to the UE 100 (step S51). The transmission of the AI/ML model itself uses a large number of resources compared to other data. In addition, when model inference is not performed in the UE 100, transmission of the trained AI/ML model by the network apparatus 400 becomes useless. Even when model inference is performed in the UE 100, when the UE 100 receives the trained AI/ML model, there may be a case that model inference using the trained AI/ML model cannot be performed in consideration of the capability of the UE 100. That is, the operation example of the model identification illustrated in FIG. 12C also focuses only on the model identification in a way similar to the first operation example and the second operation example, and does not consider the entire LCM. Hence, the UE 100 may not be able to efficiently perform the LCM operation.

In the third operation example, the network apparatus 400 transmits the meta information to the UE 100 instead of transmitting the trained AI/ML model. Specifically, first, a network apparatus (for example, the network apparatus 400) causes an AI/ML model to perform training. Second, the network apparatus transmits identification information (for example, model ID) of the AI/ML model and additional information (for example, meta information) of the AI/ML model to the user equipment (for example, the UE 100). Third, the additional information is used, by the user equipment, for one of determining whether to perform inference of the AI/ML model or determining whether to transmit a parameter (for example, inference data) used for inference to the network apparatus.

Thus, the UE 100 can determine whether the model inference is feasible based on the additional information. Further, the UE 100 can determine whether the model parameter can be transmitted to the network apparatus 400 based on the additional information. Accordingly, the UE 100 can efficiently perform the LCM operations (for example, model inference) by using the additional information.

The third operation example will be described in detail below. In the third operation example, in a way similar to the first operation example and the second operation example, the network side model and the two-sided model will be described separately in consideration of a scene in which inference is executed.

### 3.1. (3-1)-th Operation Example

In the present operation example, with respect to Type B2 (model ID is identified by using radio signaling and model identification is initiated by the network apparatus 400), there will be described an operation example when model inference is performed on the network apparatus 400 side (i.e., network side model).

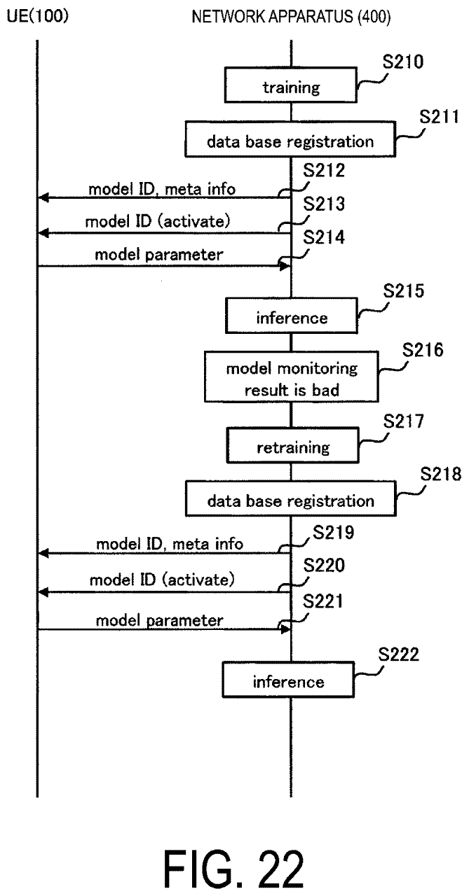

FIG. 22 is a diagram illustrating an operation example according to the first embodiment.

As illustrated in FIG. 22, in step S210, the network apparatus 400 (for example, the controller 230 of the gNB 200) performs model training and generates a trained AI/ML model. The step S210 represents Type B2 in which model identification is initiated by the network apparatus 400.

In step S211, the network apparatus 400 (for example, the controller 230 of the gNB 200) may store, to the memory, the model ID of the trained AI/ML model and the meta information used when generating the trained AI/ML model.

In step S212, the network apparatus 400 (for example, the transmitter 210 of the gNB 200) transmits the model ID and the meta information to the UE 100. The network apparatus 400 may transmit the model ID and the meta information by using the control data. When the present step is compared with FIG. 12C, the meta information is transmitted instead of the AI/ML model. In the present operation example, the AI/ML model is not transmitted, and thus a radio resource can effectively be used. The receiver 110 of the UE 100 receives the model ID and the meta information. Note that the meta information may be identical to the meta information described in the first operation example.

In step S213, the network apparatus 400 (for example, the transmitter 210 of the gNB 200) designates the model ID and transmits an instruction to perform model inference of the trained AI/ML model designated by the model ID to the UE 100. Note that the instruction to perform may be an instruction indicating that model inference is performed in the network apparatus 400, instead of an instruction to perform model inference to be performed in the UE 100. Alternatively, since the model inference is performed in the network apparatus 400, the instruction may be an instruction to transmit for instructing to transmit a model parameter necessary for model inference (for example, inference data) to the network apparatus 400. The network apparatus 400 may transmit the instruction to transmit by using the control data. The receiver 110 of the UE 100 receives the instruction to transmit.

In step S214, the controller 130 of the UE 100 determines whether the model parameter is transmitted to the network apparatus 400 by using the meta information in response to the reception of the instruction to perform. As described in the first operation example, the meta information may include, as an application condition, information on a position where the model inference is feasible. In the trained AI/ML model, the model parameter acquired in a specific region may be used to perform model inference. Hence, the model parameter acquired in a region other than the region may not be necessary for the model inference. The controller 130 of the UE 100, for example, acquires position information at the time of acquiring the model parameter by using a GNSS function and comparing the position information with the position information included in the meta information, and thus can determine whether the model parameter is the model parameter necessary for the trained AI/ML model. For example, the controller 130 may determine to transmit the model parameter to the network apparatus 400 when the position information at the time of acquiring the model parameter matches the position information included in the meta information, and may determine not to transmit the model parameter to the network apparatus 400 when the position information at the time of acquiring the model parameter does not match the position information included in the meta information. In the following description, it is assumed that the controller 130 has determined to transmit the model parameter. Note that the determining of whether the model parameter is transmitted may be performed at the timing when the UE 100 receives the model ID in step S212. In step S214, the transmitter 120 of the UE 100 transmits the model parameter. The network apparatus 400 (for example, the receiver 220 of the gNB 200) receives the model parameter.

In step S215, the network apparatus 400 (for example, the controller 230 of the gNB 200) performs model inference using the trained AI/ML model by using the model parameter.

In step S216, the network apparatus 400 (for example, the controller 230 of the gNB 200) detects that the result of the model inference is according to expectation or worse.

In step S217, the network apparatus 400 (for example, the controller 230 of the gNB 200) retrains the trained AI/ML model and generates an updated AI/ML model.

Thereafter, step S218 to step S222 are the same as step S211 to step S215, respectively, except that the target is the updated AI/ML model.

### 3.2. Operation Example of Type B2 and Two-Sided Model

Next, with respect to Type B2, an operation example of the two-sided model will be described. In the present operation example, two operation examples in total will be described. That is, there will be described a case that the identical trained AI/ML model is used for model inference in the UE 100 and the network apparatus 400 and a case that different trained AI/ML models are used for model inference in the UE 100 and the network apparatus 400.

### 3.2.1. When Identical Trained AI/ML Model Is Used

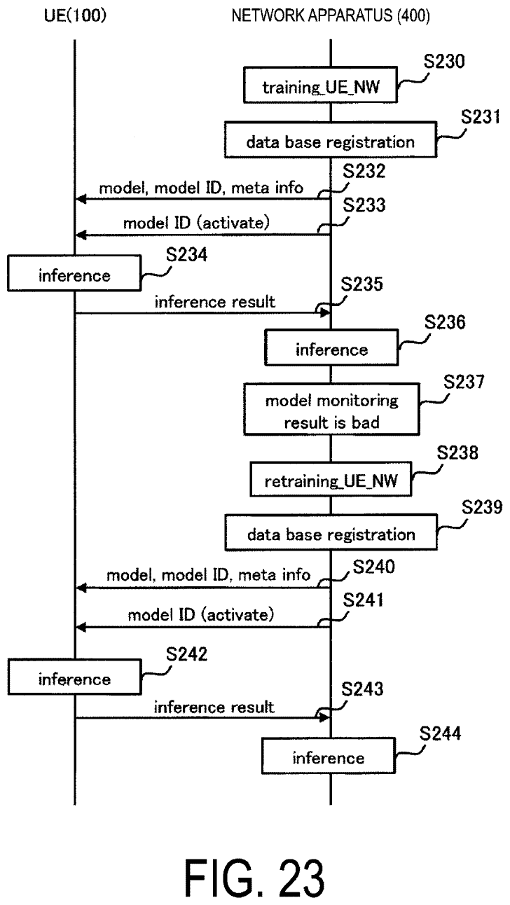

FIG. 23 illustrates an operation example when the identical trained AI/ML model (“UE_NW”) is used. That is, FIG. 23 illustrates an operation example of Type B2 and the two-sided model (identical trained AI/ML model). Hereinafter, the present operation example may be referred to as the (3-2-1)-th operation example for convenience.

The following describes the differences between the present operation example and the (3-1)-th operation example (FIG. 22).

First, the target of model training, model inference, and retraining is the AI/ML model (“UE_NW”) used in common in the UE 100 and the network apparatus 400. Hence, the target of model training, model inference, and retraining is the identical AI/ML model in the UE 100 and the network apparatus 400 (step S230, step S234, step S236, step S238, step S242, and step S244).

Second, the present operation example is the two-sided model. Hence, the network apparatus 400 (for example, the transmitter 210 of the gNB 200) transmits the trained AI/ML model in addition to the model ID and the meta information (step S232). Thereafter, the controller 130 of the UE 100 performs model inference by using the trained AI/ML model (step S234). The trained AI/ML model to be the target of the model inference is identical to the model used for the model inference in the network apparatus 400. The updated AI/ML model as well, in a way similar to the trained AI/ML model, is transmitted to the UE 100 (step S240) and is used for model inference (step S242).

Third, the transmitter 120 of the UE 100 transmits the inference result (inference result data) to the network apparatus 400 (step S235), and the network apparatus 400 (for example, the controller 230 of the gNB 200) performs model inference by using the inference result (step S236).

### 3.2.2. When Different Trained AI/ML Models Are Used

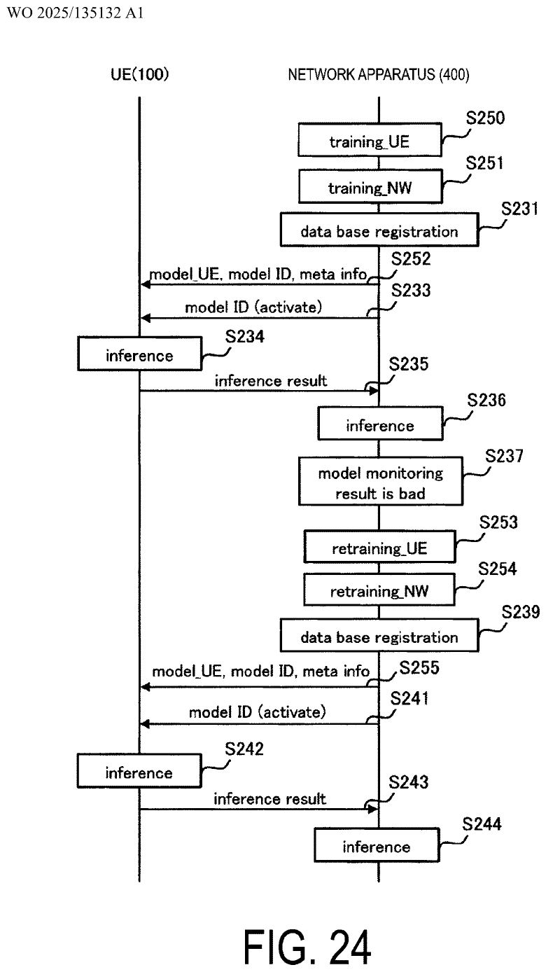

FIG. 24 illustrates an operation example when different trained AI/ML models are used. That is, FIG. 24 illustrates an operation example of Type B2 and the two-sided model (different trained AI/ML models). Hereinafter, the present operation example may be referred to as the (3-2-2)-th operation example for convenience.

The following describes the differences between the present operation example and the (3-2-1)-th operation example (FIG. 23).

First, the difference is that the target of model training and retraining is divided into the AI/ML model for the UE 100 and the AI/ML model for the network apparatus 400. Hence, the network apparatus 400 (for example, the controller 230 of the gNB 200) separately performs model training of the AI/ML model for the UE 100 and model training of the AI/ML model for the network apparatus 400 (step S250 and step S251). Further, the network apparatus (for example, the transmitter 210 of the gNB 200) transmits the trained AI/ML model for the UE 100 (“model_UE”) to the UE 100 (step S252). The same applies to retraining (step S253 to step S255).

Second, the difference is that the processing targets are the AI/ML model for the UE 100 and the AI/ML model for the network apparatus 400. For example, the network apparatus 400 (for example, the transmitter 210 of the gNB 200) transmits an instruction to perform model inference to the UE 100 (step S252) designating the model ID, but the target of the instruction to perform is the trained AI/ML model for the UE 100. The same applies to retraining (step S255).

### Other Embodiments

In the first embodiment described above, the supervised learning has mainly been described. However, the present disclosure is not limited thereto. For example, unsupervised learning or reinforcement learning may be applied to the first embodiment.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

In other words, the UE 100 may be a terminal function unit (a type of communication module) for a base station to control a repeater that performs signal relay. Such terminal function unit is referred to as an MT. Examples of the MT include a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

There may be provided a program causing a computer to execute each of the processing operations performed by the UE 100, the gNB 200, or the network apparatus 400. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM and/or a DVD-ROM. Circuits for executing the processing operations that the UE 100, the gNB 200, or the network apparatus 400 respectively perform may be integrated, and at least a part of the UE 100, the gNB 200, or the network apparatus 400 may be configured as a semiconductor integrated circuit (chipset or System on a Chip (SoC)).

The functions achieved by the UE 100, the gNB 200, or the network apparatus 400 may be implemented in circuitry or processing circuitry programmed to achieve the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. Similarly, the phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The functions achieved by the UE 100, the gNB 200, or the network apparatus 400 may be implemented in circuitry or processing circuitry programmed to achieve the described functions, including a general-purpose processor, a special-purpose processor, an integrated circuit, application specific integrated circuits (ASICs), a central processing unit (CPU), a conventional circuit, and/or combinations thereof. The processor may include transistors and/or other circuits and may be considered a circuitry or a processing circuitry. The processor may be a programmed processor that executes a program stored in the memory.

As used herein, a circuitry, a unit, means are hardware programmed to achieve, or hardware performing, the described functions. The hardware may be any hardware disclosed herein or any hardware programmed to achieve or known to perform the described functions.

When the hardware is a processor that is considered to be a type of circuitry, the circuitry, means, or a unit is a combination of hardware and software used to configure the hardware and/or the processor.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTARY NOTES

The above is summarized as follows.

### Supplementary Note 1

A communication control method for a user equipment in a mobile communication system, the communication control method including the steps of:
acquiring, by the user equipment, model identification information for identifying an AI/ML model and additional information of the AI/ML model; and
transmitting, by the user equipment, the model identification information to a network apparatus, in which the transmitting includes transmitting, by the user equipment, the model identification information to the network apparatus when the user equipment determines that the inference on the AI/ML model is possible based on the additional information.

### Supplementary Note 2

The communication control method according to Supplementary Note 1, in which
the acquiring includes acquiring, by the user equipment, the AI/ML model, and
the communication control method further includes performing, by the user equipment, inference by using the AI/ML model.

### Supplementary Note 3

The communication control method according to Supplementary Note 1 or 2, in which
the transmitting includes, by the user equipment, determining that the inference is possible and transmitting the model identification information to the network apparatus when determining that a parameter used for the inference is acquirable based on the additional information.

### Supplementary Note 4

The communication control method according to any one of Supplementary Notes 1 to 3, in which
inference on the AI/ML model is performed by the network apparatus.

### Supplementary Note 5

The communication control method according to any one of Supplementary Notes 1 to 4, in which
the additional information includes at least one selected from the group consisting of a type of data used for the inference, an application condition under which the AI/ML model is applied, a use case to which the AI/ML model is applied, and version information of the AI/ML model.

### Supplementary Note 6

The communication control method according to any one of Supplementary Notes 1 to 5, in which
the acquiring includes receiving, by the user equipment, the model identification information and the additional information from an external server.

### Supplementary Note 7

A communication control method for a user equipment in a mobile communication system, the communication control method including the steps of:
causing, by the user equipment, an AI/ML model to perform training; and
transmitting, by the user equipment, a parameter used for training and additional information of the AI/ML model to a network apparatus,
in which training of the AI/ML model is performed in the network apparatus by using the parameter.

### Supplementary Note 8

The communication control method according to any one of Supplementary Notes 1 to 7, in which
inference of the AI/ML model is performed in the user equipment and the network apparatus.

### Supplementary Note 9

The communication control method according to any one of Supplementary Notes 1 to 8, in which
the additional information includes at least one selected from the group consisting of data used for the inference, a condition under which the AI/ML model is applied, a use case to which the AI/ML model is applied, and version information of the AI/ML model.

### Supplementary Note 10

The communication control method according to any one of Supplementary Notes 1 to 9, in which
the AI/ML model trained in the user equipment and the AI/ML model trained in the network apparatus are different AI/ML models.

### Supplementary Note 11

A communication control method of a network apparatus in a mobile communication system, the communication control method including the steps of:
causing, by the network apparatus, an AI/ML model to perform training; and
transmitting, by the network apparatus, identification information of the AI/ML model and additional information of the AI/ML model to a user equipment,
in which the additional information is used, in the user equipment, for one of determining whether to perform inference of the AI/ML model or determining whether to transmit a parameter used for inference to the network apparatus.

### Supplementary Note 12

The communication control method according to any one of Supplementary Notes 1 to 11, further including the steps of:
receiving, by the network apparatus, the parameter from the user equipment; and
performing, by the network apparatus, inference by using the AI/ML model.

### Supplementary Note 13

The communication control method according to any one of Supplementary Notes 1 to 12, further including the steps of:
receiving, by the network apparatus, an inference result of the AI/ML model from the user equipment; and
performing, by the network apparatus, inference of the AI/ML model by using the inference result.

### REFERENCE SIGNS

1: Mobile communication system
20: 5GC (CN)
100: UE
110: Receiver
120: Transmitter
130: Controller
200: gNB
210: Transmitter
220: Receiver
230: Controller
400: Network apparatus
500: External server

1. A communication control method for a user equipment in a mobile communication system, the communication control method comprising:
acquiring, by the user equipment, model identification information for identifying an artificial intelligence (AI)/machine learning (ML) model and additional information of the AI/ML model; and
transmitting, by the user equipment, the model identification information to a network apparatus,
wherein the transmitting comprises transmitting, by the user equipment, the model identification information to the network apparatus when the user equipment determines that the inference on the AI/ML model is possible based on the additional information.

2. The communication control method according to claim 1, wherein
the acquiring comprises acquiring, by the user equipment, the AI/ML model, and
the communication control method further comprises performing, by the user equipment, inference by using the AI/ML model.

3. The communication control method according to claim 1, wherein
the transmitting comprises, by the user equipment, determining that the inference is possible and transmitting the model identification information to the network apparatus when determining that a parameter used for the inference is acquirable based on the additional information.

4. The communication control method according to claim 2, wherein
inference on the AI/ML model is performed by the network apparatus.

5. The communication control method according to claim 1, wherein
the additional information comprises at least one selected from the group consisting of a type of data used for the inference, an application condition under which the AI/ML model is applied, a use case to which the AI/ML model is applied, and version information of the AI/ML model.

6. The communication control method according to claim 1, wherein
the acquiring comprises receiving, by the user equipment, the model identification information and the additional information from an external server.

7. A communication control method for a user equipment in a mobile communication system, the communication control method comprising:
causing, by the user equipment, an AI/ML model to perform training; and
transmitting, by the user equipment, a parameter used for training and additional information of the AI/ML model to a network apparatus,
wherein training of the AI/ML model is performed in the network apparatus by using the parameter.

8. The communication control method according to claim 7, wherein
inference of the AI/ML model is performed in the user equipment and the network apparatus.

9. The communication control method according to claim 7, wherein
the additional information comprises at least one selected from the group consisting of data used for the inference, a condition under which the AI/ML model is applied, a use case to which the AI/ML model is applied, and version information of the AI/ML model.

10. The communication control method according to claim 7, wherein
the AI/ML model trained in the user equipment and the AI/ML model trained in the network apparatus are different AI/ML models.

11. A communication control method of a network apparatus in a mobile communication system, the communication control method comprising:
causing, by the network apparatus, an AI/ML model to perform training; and
transmitting, by the network apparatus, identification information of the AI/ML model and additional information of the AI/ML model to a user equipment,
wherein the additional information is used, in the user equipment, for one of determining whether to perform inference of the AI/ML model or determining whether to transmit a parameter used for inference to the network apparatus.

12. The communication control method according to claim 11, further comprising:
receiving, by the network apparatus, the parameter from the user equipment; and
performing, by the network apparatus, inference by using the AI/ML model.

13. The communication control method according to claim 12, further comprising:
receiving, by the network apparatus, an inference result of the AI/ML model from the user equipment; and
performing, by the network apparatus, inference of the AI/ML model by using the inference result.
